(19) United States
(12) Patent Application Publication
(10) Pub. No.: US 2010/0103934 A1
(43) Pub. Date: Apr. 29, 2010

(54) METHOD, SYSTEM AND APPARATUS FOR ADMISSION CONTROL OF MULTICAST OR UNICAST

(75) Inventors: Jun Li, Shenzhen (CN); Huailong Gu, Shenzhen (CN); Ting Zou, Shenzhen (CN); Zhenzhu Lv, Shenzhen (CN); Xiaolian Zhang, Shenzhen (CN)

Correspondence Address: Huawei Technologies Co., Ltd.;c/o Darby & Darby P.C., P.O. Box 770, Church Street Station, New York, NY, 10008-0770, US

(73) Assignee: HUAWEI TECHNOLOGIES CO., LTD., Shenzhen (CN)

(21) Appl. No.: 12/650,150

(22) Filed: Dec. 30, 2009

Related U.S. Application Data
(63) Continuation of application No. PCT/CN2008/072112, filed on Aug. 22, 2008.

(30) Foreign Application Priority Data
Aug. 24, 2007 (CN) 200710138794.8

(51) Int. Cl. H04L 12/56

(52) U.S. Cl. 370/390

(57) ABSTRACT

The embodiment of this invention discloses a method, a system and an apparatus for admission control of multicast or unicast. The method for admission control of multicast comprises: a network device receives a multicast request and executes admission control operation of multicast resources according to the multicast request; when multicast resources are not sufficient, the network device sends an outer resources request to a resources admission control device, and executes multicast operation according to the results of admission control operation returned by the resources admission control device responsive to said outer resources request. The method for admission control of unicast comprises: a resources admission control device receives a unicast resources request and executes admission control operation of unicast resources according to the unicast resources request; when the unicast resources are not sufficient, the resources admission control device sends an outer resources request to a network device; the resources admission control device executes unicast operation according to the results of admission control operation returned by the network device responsive to said outer resources request. The embodiment of this invention guarantees fast handoff of multicast service channel in the case of implementing resources share of multicast services and unicast services, and the implementation is simple.

### CROSS-REFERENCE TO RELATED APPLICATIONS

This application is a continuation of International Application No. PCT/CN2008/072112, filed on Aug. 22, 2008, which claims priority to Chinese Patent Application No. 200710138794.8, filed on Aug. 24, 2007, both of which are hereby incorporated by reference in their entireties.

### FIELD OF THE INVENTION

The present invention relates to a communication technology, and in particular, to a Method, System, and Apparatus for Admission Control (AC) of Multicast or Unicast.

### BACKGROUND OF THE INVENTION

For services that consume a lot of bandwidths and do not tolerate any loss of packets, such as the Internet Protocol Television (IPTV) video, a network bandwidth, and especially, a user link bandwidth is generally very limited. To ensure effective development of video services and the Quality of Service (QoS), a network must be provided with the Resource Management (RM) function and the AC function.

IPTV services are classified into two types, namely, multicast/broadcast video services and unicast video services, such as BTV and Video On Demand (VOD). The difference between the multicast service mode and the unicast service mode is great, and therefore, implementations of the AC function are different.

In the prior art, multicast AC is performed on an Access Node (AN). The AN includes an X-Resource and Admission Control Function (X-RACF). After the AN receives a multicast request sent by a User Equipment (UE), the X-RACF judges whether there is sufficient resources; that is, the X-RACF judges whether a user link bandwidth meets the bandwidth requirement when a UE requests to join a channel, or judges whether the number of channels that the UE has joined exceeds the specified maximum number. If the bandwidth is insufficient or the number of channels exceeds the maximum number, AC fails, and the AN rejects the join request of the UE.

Generally, unicast AC is completed by an independent RM server. The RM server includes an Access Resource and Admission Control Function (A-RACF). The A-RACF knows the network topology and manages an end-to-end bandwidth from an Application Function (AF), such as a unicast video server, to a UE. Therefore, when a UE requests a unicast video service, the AF requests resources from the A-RACF; the A-RACF judges whether an end-to-end bandwidth is met, and then returns a resource request result; the AF determines whether to admit the service according to the resource request result.

One solution in the prior art is as follows: A multicast service and a unicast service reserve access line resources respectively, and do not occupy the access line resources of each other; an X-RACF implements multicast AC of an access line; and an A-RACF implements unicast AC of an access line. Multicast AC and unicast AC are independent without mutual impacts. Therefore, multicast services cannot share bandwidth resources with unicast services. As a result, bandwidth resources are wasted. In addition, when multicast bandwidth resources are insufficient, multicast services cannot be provided for users.

In another solution of the prior art, an A-RACF implements not only unicast AC of an access line but also the following function: when joining a multicast channel, a UE sends a multicast request to an AN; the AN reports information about a channel joined by the UE to the A-RACF; the A-RACF judges whether a user link bandwidth meets the requirements; if the user link bandwidth does not meet the requirements, the A-RACF notifies the AN to reject the join request of the UE. The AN reports multicast join information of the UE, and the A-RACF performs AC in a unified manner. Thus the multicast implementation mode and the unicast implementation mode are unified, and the resource waste is avoided. In the solution, when a multicast traffic channel is switched, interworking with the A-RACF is required; therefore, the switching takes a long time, and the user experience is poor. In addition, implementation of the solution is complex. The switching frequency of multicast services is higher than that of unicast services. When all users switch channels, the AN reports information about channel switching of the users to the A-RACF. When many TV users switch channels frequently, a huge amount of information is exchanged, and the AN is required to have very high performance. The AN, however, does not perform AC.

### SUMMARY OF THE INVENTION

A multicast AC method is provided in embodiments of the present invention so that fast switching of multicast traffic channels is ensured when multicast service resources and unicast service resources are shared.

A multicast AC system and apparatus are provided in embodiments of the present invention so that fast switching of multicast traffic channels is ensured when multicast service resources and unicast service resources are shared.

A unicast AC method is provided in embodiments of the present invention so that multicast service resources and unicast service resources can be shared. In addition, the implementation is simple.

A unicast AC system and apparatus are provided in embodiments of the present invention so that multicast service resources and unicast service resources can be shared. In addition, the implementation is simple.

To achieve the above objectives, the technical solution of embodiments of the present invention is implemented as follows:

A multicast AC method includes: presetting a multicast resource threshold for multicast services; receiving, by a network device, a multicast request and performing multicast resource AC according to the multicast request; and sending an external resource request to a resource AC device when a sum of currently occupied multicast resources and multicast resource required in the multicast is more than the preset multicast resource threshold, and performing a multicast operation according to an AC operation result returned by the resource AC device in response to the external resource request.

A multicast AC system includes a network device and a resource AC device.

The network device is configured to: preset a multicast resource threshold for multicast services, receive a multicast request, perform multicast resource AC according to the multicast request, send an external resource request to the resource AC device when a sum of currently occupied multicast resources and multicast resource required in the multicast is more than the preset multicast resource threshold, and perform a multicast operation according to an AC operation result returned by the resource AC device in response to the external resource request.

The resource AC device is configured to receive the external resource request, perform AC according to the external resource request, and return the AC operation result to the network device.

A network device includes: a multicast request interface module, configured to receive a multicast request; a resource request interface module, configured to:\ send an external resource request to a resource AC device, and receive an AC operation result returned by the resource AC device in response to the external resource request; and an AC operating module, configured to: perform multicast resource AC according to the multicast request, send the external resource request to the resource AC device through the resource request interface module when multicast resources are insufficient, and perform a multicast operation according to the AC operation result returned by the resource AC device in response to the external resource request.

A resource AC device includes: a resource request interface module, configured to receive an external resource request sent by a network device when multicast resources are insufficient; and an AC operating module, configured to:\ perform AC according to the external resource request, and return an AC operation result to the network device through the resource request interface module.

A unicast AC method includes: presetting a unicast resource threshold for unicast services; receiving, by a resource AC device, a unicast resource request and performing unicast resource AC according to the unicast resource request; sending an external resource request to a network device when a sum of currently occupied unicast resources and unicast resources required in the unicast request is more than the preset unicast resource threshold; and performing a unicast operation according to an AC operation result returned by the network device in response to the external resource request.

A unicast AC system includes a resource AC device and a network device.

The resource AC device is configured to: receive a unicast resource request, perform unicast resource AC according to the unicast resource request, send an external resource request to the network device when unicast resources are insufficient, and perform a unicast operation according to an AC operation result returned by the network device in response to the external resource request.

The network device is configured to perform AC according to the external resource request, and return the AC operation result to the resource AC device.

A resource AC device includes: a unicast resource request interface module, configured to receive a unicast resource request; a resource request interface module, configured to send an external resource request to a network device, and receive an AC operation result returned by the network device in response to the external resource request; and an AC operating module, configured to: perform unicast resource AC according to the unicast resource request, send the external resource request to the network device through the resource request interface module when unicast resources are insufficient, and perform a unicast operation according to the AC operation result returned by the network device in response to the external resource request.

A network device includes: a resource request interface module, configured to receive an external resource request sent by a resource AC device when unicast resources are insufficient; and an AC operating module, configured to perform AC according to the external resource request, and return an AC operation result to the resource AC device through the resource request interface module.

In the multicast AC method, system and device provided in embodiments of the present invention, multicast resources are allocated for multicast services. When performing AC according to a received multicast request and determining that multicast resources are insufficient, the AN requests external resources from the A-RACF. The A-RACF performs AC for external resources. The AN performs the corresponding operation according to the AC operation result. In the technical solution of embodiments of the present invention, when determining that resources are insufficient, the AN may request the A-RACF to allocate resources for multicast services. Thus, multicast service resources and unicast service resources can be shared, and the resource waste is avoided. In addition, the AN does not need to report channel switching information to the A-RACF, and therefore, the AN does not need to exchange a huge amount of information with the A-RACF when many users switch channels, thus reducing the implementation complexity of the AN. User requirements are met without any impact on other service streams, and multicast services are provided for users. During channel switching, without interworking with the A-RACF, multicast replication can be implemented, thus reducing the switching delay and implementing fast switching of channels.

In the unicast AC method, system and device provided in embodiments of the present invention, multicast resources are allocated for unicast services. When performing AC according to a unicast request and determining that unicast resources are insufficient, the A-RACF requests external resources from the AN that has a built-in X-RACF. The AN performs resource AC and returns a result. The A-RACF performs the corresponding operation according to the AC operation result. Therefore, with the technical solution of embodiments of the present invention, multicast service resources and unicast service resources can be shared, and the resource waste is avoided. In addition, the implementation of the method is simple.

### BRIEF DESCRIPTION OF THE DRAWINGS

FIG. 1 is a flowchart of a multicast AC method according to an embodiment of the present invention;

FIG. 2 is a flowchart of a multicast request/release method when the resource sum is less than a preset threshold according to an embodiment of the present invention;

FIG. 3 is a flowchart of a multicast request/release method when the resource sum is more than a preset threshold according to an embodiment of the present invention;

FIG. 4 is a flowchart of a multicast request/rejection method when the resource sum is more than a preset threshold according to an embodiment of the present invention;

FIG. 5 shows a multicast AC system according to an embodiment of the present invention;

FIG. 6 shows a network device according to an embodiment of the present invention;

FIG. 7 shows a resource AC device according to an embodiment of the present invention;

FIG. 8 is a flowchart of a unicast AC method according to an embodiment of the present invention;

FIG. 9 is a flowchart of a unicast request/release method when the resource sum is less than a preset threshold according to an embodiment of the present invention;

FIG. 10 is a flowchart of a unicast request/release method when the resource sum is more than a preset threshold according to an embodiment of the present invention;

FIG. 11 is a flowchart of a unicast request/rejection method when the resource sum is more than a preset threshold according to an embodiment of the present invention;

FIG. 12 shows a unicast AC system according to an embodiment of the present invention;

FIG. 13 shows a resource AC device according to an embodiment of the present invention; and

FIG. 14 shows a network device according to an embodiment of the invention.

### DETAILED DESCRIPTION OF THE INVENTION

The present invention is described in detail with reference to the accompanying drawings and specific embodiments hereunder.

A multicast and/or a unicast AC method provided in embodiments of the present invention are applied in a communication system that includes a network device and a resource control device. The network device may be an AN, an aggregation device, a Broadband Remote Access Server (BRAS), and an SR that have a built-in X-RACF. The resource control device may be an A-RACF.

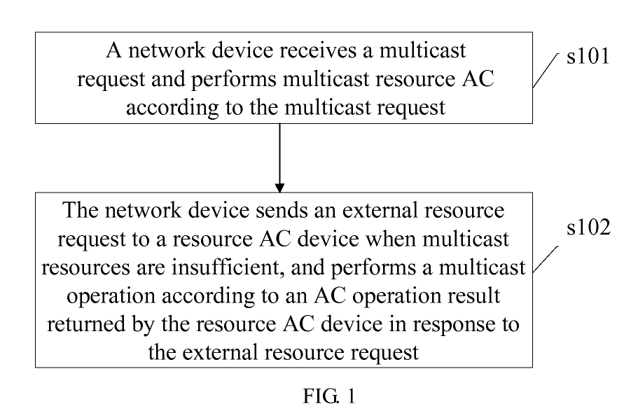

A multicast AC method in embodiments of the present invention includes allocating multicast resources for multicast services in advance. A network device completes multicast AC for an access line and allocates multicast resources for multicast services. FIG. 1 is a flowchart of a multicast AC method in an embodiment of the present invention. FIG. 1 includes the following steps:

s101. A network device receives a multicast request and performs multicast resource AC according to the multicast request.

s102. The network device sends an external resource request to a resource AC device when multicast resources are insufficient, and performs a multicast operation according to an AC operation result returned by the resource AC device in response to the external resource request.

In this embodiment, the multicast AC method further includes setting a multicast resource threshold for multicast services when allocating multicast resources for multicast services.

In the embodiments hereunder, a network device is an AN that has a built-in X-RACF, and a resource AC device is an A-RACF.

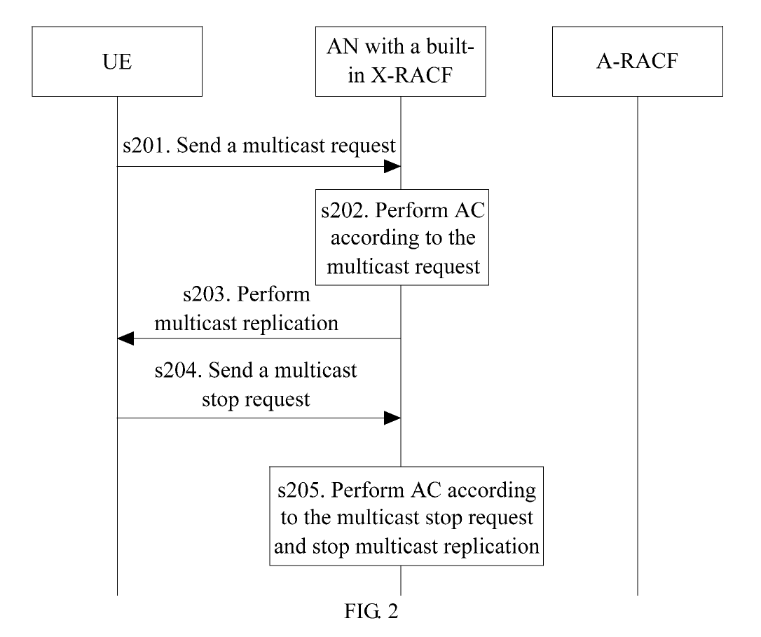

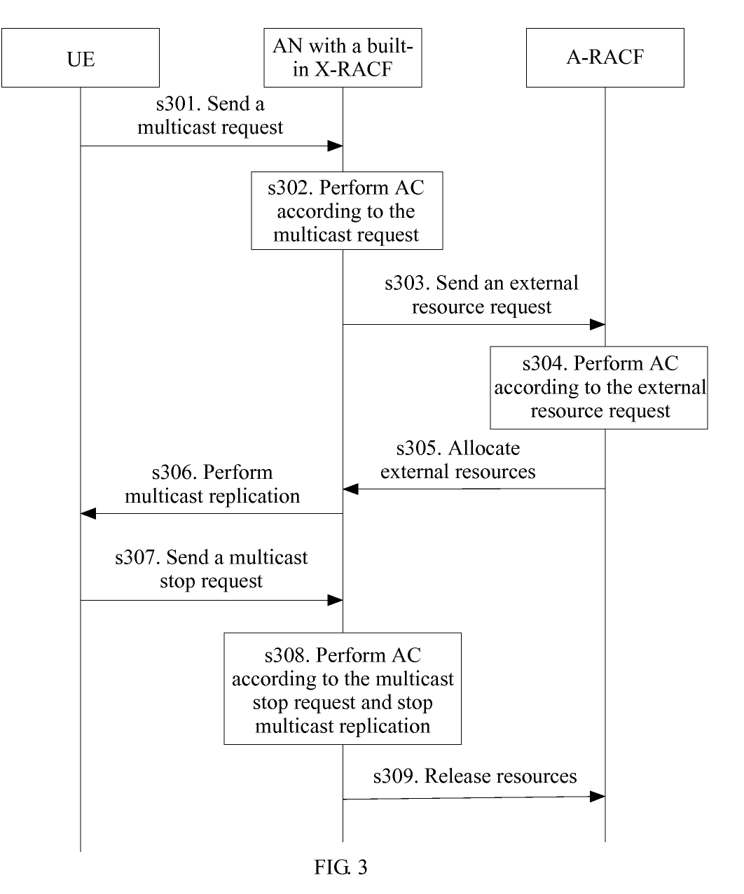

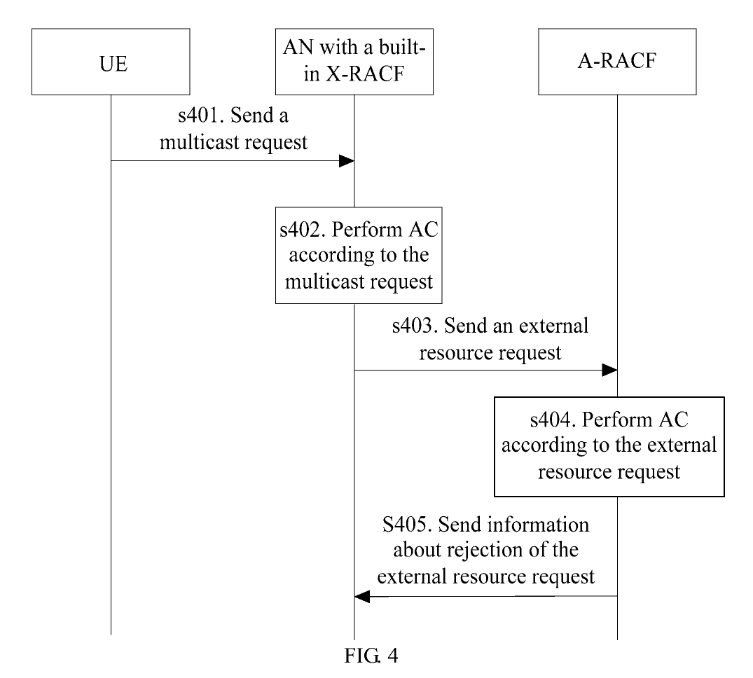

When the X-RACF performs AC according to the multicast request in step s102, the X-RACF checks whether the sum of the currently occupied multicast resources and the resources required in the multicast request is more or less than the preset multicast resource threshold. When the sum is less than the threshold, a process is executed according to the method flowchart shown in FIG. 2. When the sum is more than the threshold, a process is executed according to the method flowchart shown in FIG. 3 or FIG. 4.

FIG. 2 is a flowchart of a multicast request/release method when the resource sum is less than a preset threshold in an embodiment of the present invention. FIG. 2 includes the following steps:

s201. A UE sends a multicast request such as an Internet Group Management Protocol (IGMP) join message to an AN that has a built-in X-RACF.

The multicast request in this step may be a request for joining a multicast channel or a request for switching from one multicast traffic channel to another multicast traffic channel.

s202. The X-RACF performs AC according to the multicast request. In this step, the sum of the currently occupied multicast resources and the multicast resources required in the multicast request is less than a preset multicast resource threshold, and therefore, multicast resources are sufficient.

s203. The AN performs multicast replication according to the multicast request.

When the UE does not require multicast services, the AC process of multicast stop includes the following steps:

s204. The UE sends a multicast stop request such as an IGMP leave message to the AN that has a built-in X-RACF.

s205. The X-RACF performs AC according to the multicast stop request and stops multicast replication for the multicast request.

FIG. 3 is a flowchart of a multicast request/release method when the resource sum is more than a threshold in an embodiment of the present invention. FIG. 3 includes the following steps:

s301. A UE sends a multicast request such as an IGMP join message to an AN that has a built-in X-RACF.

s302. The X-RACF performs AC according to the multicast request. In this step, the sum of the currently occupied multicast resources and the multicast resources required in the multicast request is more than a preset multicast resource threshold, and therefore, multicast resources are insufficient.

s303. The X-RACF sends an external resource request to an A-RACF.

s304. The A-RACF performs AC according to the external resource request. In this step, if the sum of the currently occupied unicast resources and the multicast resources required in the external resource request is less than a preset unicast resource threshold, it indicates that unicast resources are sufficient. When determining that unicast resources are sufficient, the A-RACF admits the external resource request from the X-RACF and proceeds to step s305.

s305. The A-RACF allocates external resources for the X-RACF.

s306. The AN performs multicast replication according to the multicast request.

When the UE does not require multicast services, the AC process of multicast stop includes the following steps:

s307. The UE sends a multicast stop request such as an IGMP leave message to the AN.

s308. The X-RACF performs AC according to the multicast stop request and stops multicast replication for the multicast request.

s309. The X-RACF releases all or part of the resources allocated by the A-RACF. In this step, releasing resources may be performed in the following cases: when the X-RACF does not require the resources; after a preset timer expires; when unicast resources of the A-RACF are insufficient; or when the A-RACF requests external resources from the X-RACF after the A-RACF receives the unicast request. Releasing resources may be performed immediately, or performed according to a preset return policy, for example, a preset return threshold (a percentage or bandwidth size). For example, the X-RACF borrows a bandwidth of 5 Mbit/s from the A-RACF. When releasing resources, the X-RACF may release a bandwidth of 2 Mbit/s for the first time and release the remaining bandwidth of 3 Mbit/s for the second time according to the preset return percentage or bandwidth size.

Optionally, an X-RACF in an AN borrows unicast resources from an A-RACF, and therefore, the A-RACF may adopt the forced obtaining mode when the X-RACF in an AN uses external resources to implement multicast services; that is, when unicast resources of the A-RACF are insufficient, the A-RACF may force the X-RACF in an AN to disconnect certain multicast services and return the borrowed resources.

Optionally, the X-RACF in an AN may return the borrowed resources or other idle resources to the A-RACF according to the current actual resource usage.

FIG. 4 is a flowchart of a multicast request/rejection method when the resource sum is more than a threshold in an embodiment of the present invention. FIG. 4 includes the following steps:

Steps s401-s403 are the same as steps s301-s303, and will not be described further.

s404. The A-RACF performs AC according to the external resource request. In this step, the sum of the currently occupied unicast resources and the multicast resources required in the external resource request is more than a preset unicast resource threshold, and therefore, unicast resources are insufficient. When determining that unicast resources are insufficient, the A-RACF rejects the external resource request from the X-RACF and proceeds to step s405.

s405. The A-RACF sends information about rejection of the external resource request to the X-RACF.

This embodiment describes a case where idle multicast resources cannot meet the multicast request of the UE and the idle unicast resources of the A-RACF also cannot meet the multicast request, and therefore, the multicast request of the UE is rejected.

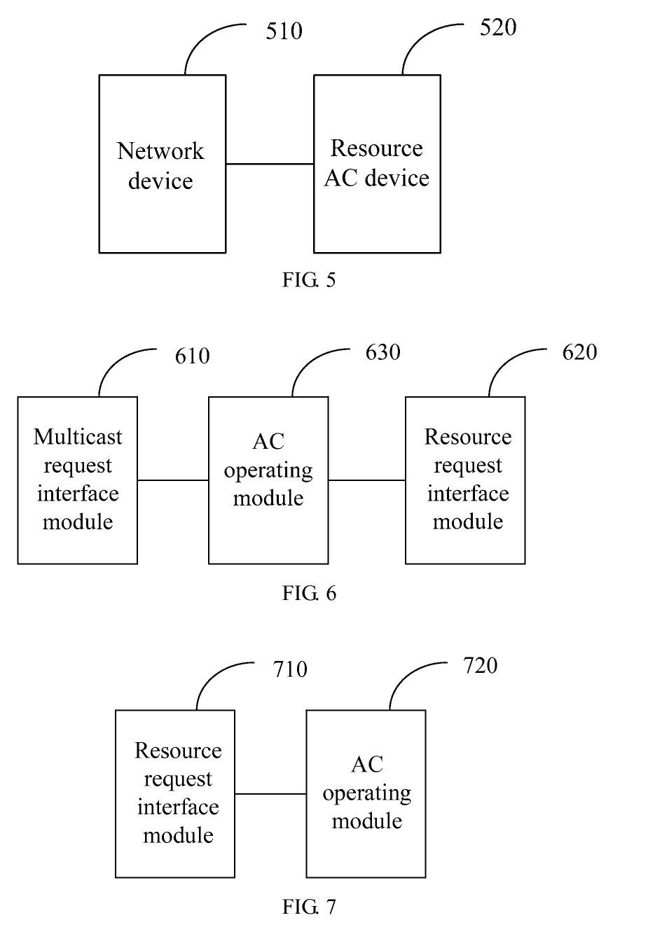

Based on the foregoing method, an embodiment of the present invention further provides a multicast AC system. As shown in FIG. 5, the system includes a network device 510 and a resource AC device 520.

The network device 510 is configured to: receive a multicast request, perform multicast resource AC according to the multicast request, send an external resource request to the resource AC device 520 when multicast resources are insufficient, and perform a multicast operation according to an AC operation result returned by the resource AC device 520 in response to the external resource request.

The resource AC device 520 is configured to receive the external resource request, perform AC according to the external resource request, and return the AC operation result to the network device 510.

Based on the foregoing method, an embodiment of the present invention further provides a network device.

As shown in FIG. 6, the network device includes: a multicast request interface module 610, configured to receive a multicast request; a resource request interface module 620, configured to send an external resource request to a resource AC device, and receive an AC operation result returned by the resource AC device in response to the external resource request; and an AC operating module 630, configured to: perform multicast resource AC according to the multicast request, send the external resource request to the resource AC device through the resource request interface module 620 when multicast resources are insufficient, and perform a multicast operation according to the AC operation result returned by the resource AC device in response to the external resource request.

Based on the foregoing method, an embodiment of the present invention further provides a resource AC device.

As shown in FIG. 7, the resource AC device includes: a resource request interface module 710, configured to receive an external resource request sent by a network device when multicast resources are insufficient; and an AC operating module 720, configured to perform AC according to the external resource request, and return an AC operation result to the network device through the resource request interface module 710.

Therefore, in the multicast AC method, system and device provided in the embodiments of the present invention, multicast resources are allocated for multicast services in advance, and a multicast resource threshold is set; when multicast resources are insufficient, an X-RACF requests external resources from an A-RACF. Thus, multicast service resources and unicast service resource can be shared; the resource utilization is improved; and the resource waste is avoided. In addition, when a user switches a channel, the X-RACF does not need to report information about channel switching to the A-RACF. Therefore, fast switching of multicast traffic channels is ensured.

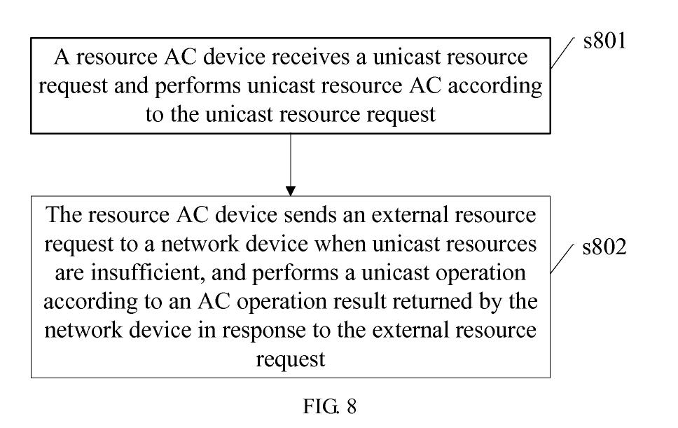

An embodiment of the present invention further provides a unicast AC method. FIG. 8 is a flowchart of a unicast AC method in an embodiment of the present invention. In this embodiment, unicast resources are allocated for unicast services in advance; the unicast resources are controlled by a resource AC device; and the resource AC device allocates unicast resources for unicast services. The method includes the following steps:

s801. A resource AC device receives a unicast resource request and performs unicast resource AC according to the unicast resource request.

s802. The resource AC device sends an external resource request to a network device when unicast resources are insufficient.

The resource AC device performs a unicast operation according to an AC operation result returned by the network device in response to the external resource request.

In this embodiment, the unicast AC method further includes setting a unicast resource threshold for unicast services when allocating unicast resources for unicast services.

In the descriptions hereunder, a resource AC device is an A-RACF, and a network device is an AN that has a built-in X-RACF.

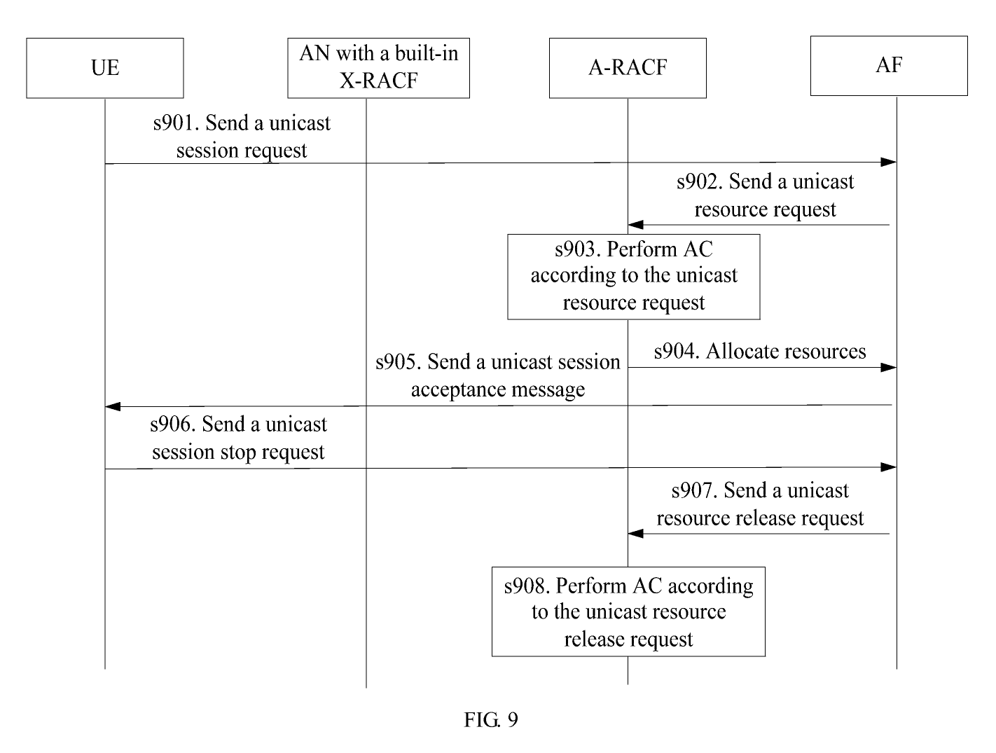

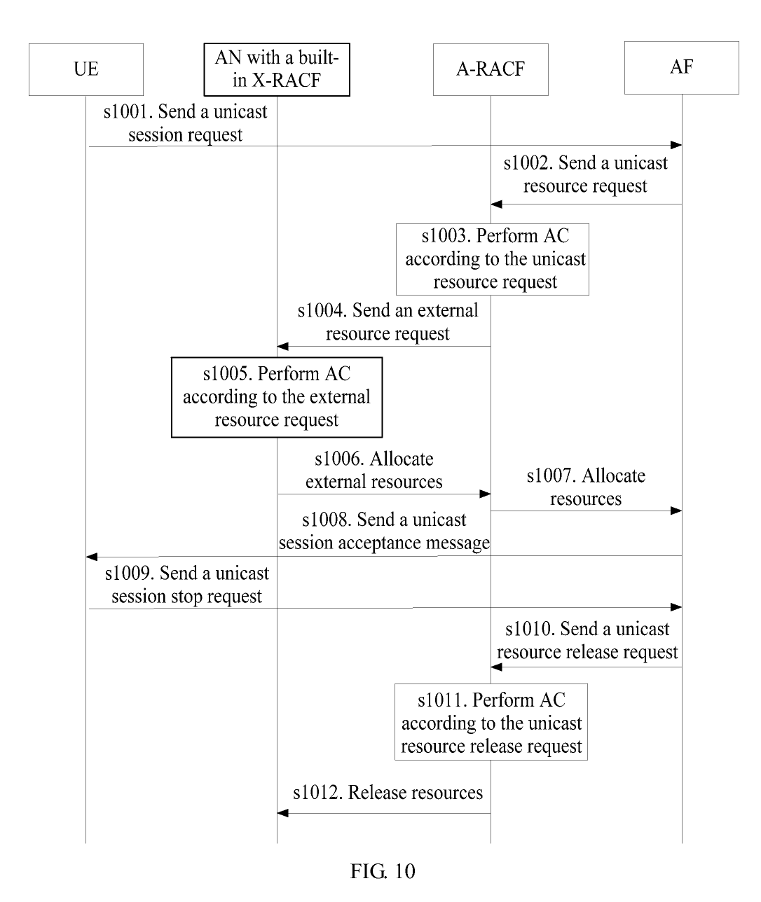

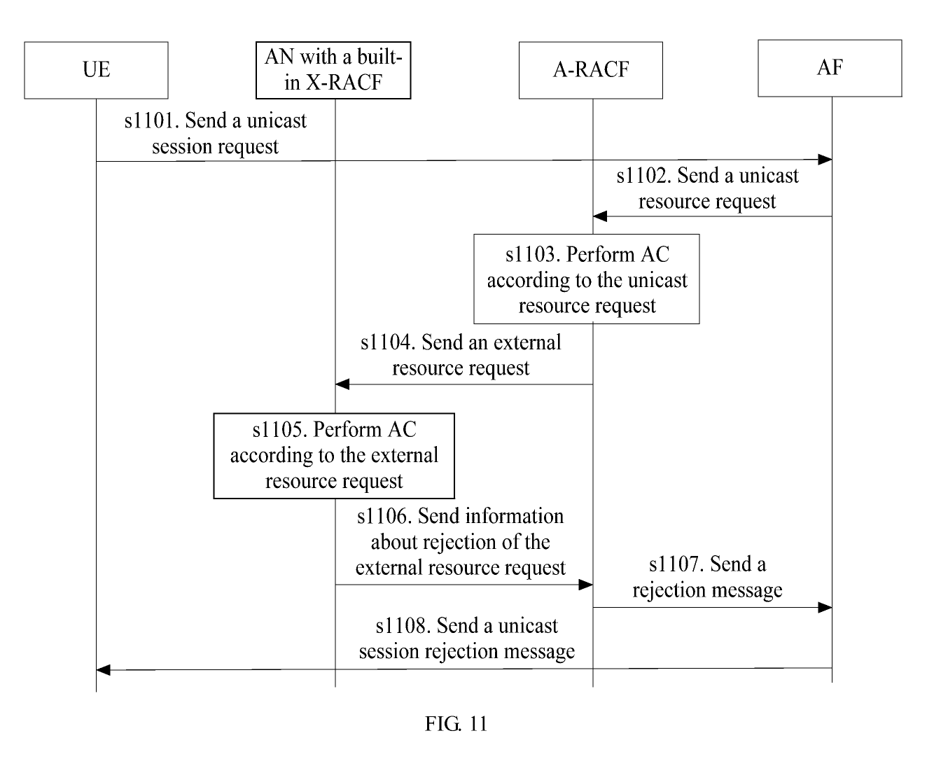

When the A-RACF performs AC according to the unicast resource request in step s802, the A-RACF checks whether the sum of the currently occupied unicast resources and the resources required in the unicast resource request is more or less than a preset unicast resource threshold. When the sum is less than the threshold, a process is executed according to the method flowchart shown in FIG. 9. When the sum is more than the threshold, a process is executed according to the method flowchart shown in FIG. 10 or FIG. 11.

FIG. 9 is a flowchart of a unicast request/release method when the resource sum is less than a preset threshold in an embodiment of the present invention. FIG. 9 includes the following steps:

s901. A UE sends a unicast session request to an AF.

s902. After receiving the unicast session request, the AF sends a unicast resource request to an A-RACF.

s903. The A-RACF performs AC according to the unicast resource request. In this step, the sum of the currently occupied unicast resources and the unicast resources required in the unicast request is less than a preset unicast resource threshold, and therefore, unicast resources are sufficient.

s904. The A-RACF allocates resources according to the unicast resource request.

s905. The AF sends a unicast session acceptance message to the UE.

When the UE does not require unicast services, the AC process of unicast stop includes the following steps:

s906. The UE sends a unicast session stop request to the AF.

s907. After receiving the unicast session stop request, the AF sends a unicast resource release request to the A-RACF.

s908. The A-RACF performs AC according to the unicast resource release request, and releases the resources allocated according to the unicast resource request.

FIG. 10 is a flowchart of a unicast request/release method when the resource sum is more than a preset threshold in an embodiment of the present invention. FIG. 10 includes the following steps:

s1001. A UE sends a unicast session request to an AF.

s1002. After receiving the unicast session request, the AF sends a unicast resource request to an A-RACF.

s1003. The A-RACF performs AC according to the unicast resource request. In this step, the sum of the currently occupied unicast resources and the unicast resources required in the unicast request is more than a preset unicast resource threshold, and therefore, unicast resources are insufficient.

s1004. The A-RACF sends an external resource request to an X-RACF.

s1005. The X-RACF performs AC according to the external resource request. In this step, the sum of the currently occupied multicast resources and the unicast resources required in the external resource request is less than a preset multicast resource threshold, and therefore, multicast resources are sufficient. When determining that multicast resources are sufficient, the X-RACF admits the external resource request from the A-RACF and proceeds to step s1006.

s1006. The X-RACF allocates external resources for the A-RACF.

s1007. The A-RACF allocates resources according to the unicast resource request.

s1008. The AF sends a unicast session acceptance message to the UE.

When the UE does not require unicast services, the AC process of unicast stop includes the following steps:

s1009. The UE sends a unicast session stop request to the AF.

s1010. After receiving the unicast session stop request, the AF sends a unicast resource release request to the A-RACF.

s1011. The A-RACF performs AC according to the unicast resource release request.

s1012. The A-RACF releases all or part of the resources allocated by the X-RACF. In this step, releasing resources may be performed in the following cases: when the A-RACF does not require the resources; after a preset timer expires; when multicast resources of the X-RACF are insufficient; or when the X-RACF requests external resources from the A-RACF after the X-RACF receives the unicast request. Releasing resources may be performed immediately, or performed according to a preset return policy, for example, a preset return threshold (a percentage or bandwidth size). For example, the A-RACF borrows a bandwidth of 5 Mbit/s from the X-RACF. When releasing resources, the A-RACF may release a bandwidth of 2 Mbit/s for the first time and release the remaining bandwidth of 3 Mbit/s for the second time according to the preset return percentage or bandwidth size.

In addition, an A-RACF borrows multicast resources from an X-RACF in an AN, and therefore, the X-RACF in an AN may adopt the forced obtaining mode when the A-RACF uses external resources to implement unicast services; that is, when multicast resources of the X-RACF in an AN are insufficient, the X-RACF in an AN may force the A-RACF to disconnect certain unicast services and return the borrowed resources.

FIG. 11 is a flowchart of a unicast request/rejection method when the resource sum is more than a preset threshold in an embodiment of the present invention. FIG. 11 includes the following steps:

Steps s1101-s1104 are the same as steps s1001-s1004, and will not be described further.

s1105. The X-RACF performs AC according to the external resource request. In this step, the sum of the currently occupied multicast resources and the unicast resources required in the external resource request is more than a preset multicast resource threshold, and therefore, multicast resources are insufficient. When determining that multicast resources are insufficient, the X-RACF rejects the external resource request from the A-RACF and proceeds to step s1106.

s1106. The X-RACF sends information about rejection of the external resource request to the A-RACF.

s1107. The A-RACF sends a rejection message to the AF.

s1108. The AF sends a unicast session rejection message to the UE.

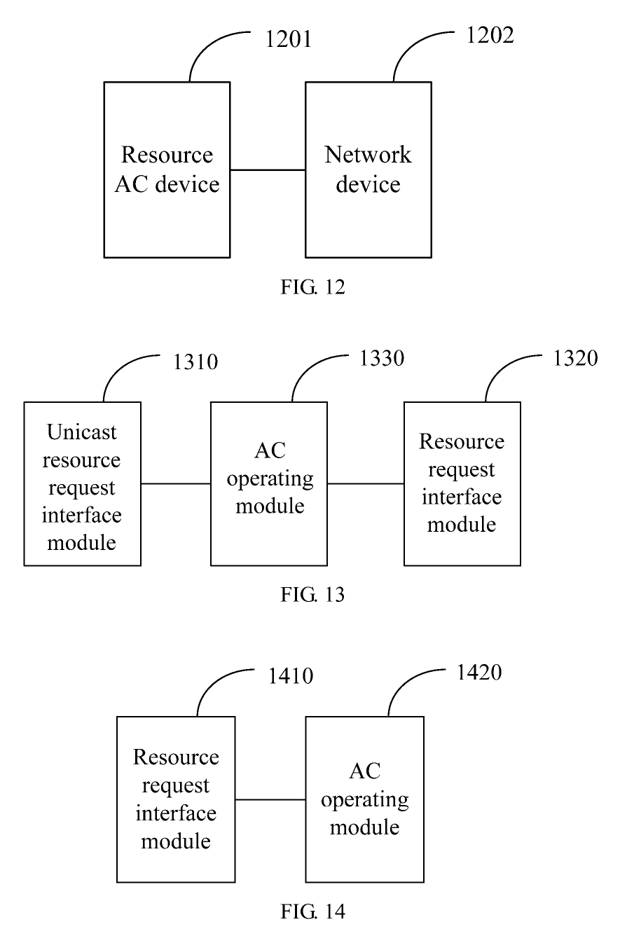

Based on the foregoing unicast AC method, an embodiment of the present invention further provides a unicast AC system. As shown in FIG. 12, the system includes a resource AC device 1201 and a network device 1202.

The resource AC device 1201 is configured to: receive a unicast resource request, perform unicast resource AC according to the unicast resource request, send an external resource request to the network device when unicast resources are insufficient, and perform a unicast operation according to an AC operation result returned by the network device in response to the external resource request.

The network device 1202 is configured to perform AC according to the external resource request, and return the AC operation result to the resource AC device.

Based on the foregoing unicast AC method, as shown in FIG. 13, an embodiment of the present invention further provides a resource AC device. The resource AC device includes: a unicast resource request interface module 1310, configured to receive a unicast resource request; a resource request interface module 1320, configured to: send an external resource request to a network device, and receive an AC operation result returned by the network device in response to the external resource request; and an AC operating module 1330, configured to: perform unicast resource AC according to the unicast resource request, send the external resource request to the network device through the resource request interface module 1320 when unicast resources are insufficient, and perform a unicast operation according to the AC operation result returned by the network device in response to the external resource request.

Based on the foregoing unicast AC method, as shown in FIG. 14, an embodiment of the present invention further provides a network device. The network device includes: a resource request interface module 1410, configured to receive an external resource request sent by a resource AC device when unicast resources are insufficient; and an AC operating module 1420, configured to perform AC according to the external resource request, and return an AC operation result to the resource AC device through the resource request interface module 1410.

Therefore, in the unicast AC method, system and device provided in the embodiments of the present invention, unicast resources are allocated for unicast services in advance, and a unicast resource threshold is set; when unicast resources are insufficient, an A-RACF requests external resources from an X-RACF. Thus, multicast service resources and unicast service resources can be shared; the resource utilization is improved; and the resource waste is avoided. In addition, the implementation of the method is simple.

It is understandable to those skilled in the art that the foregoing multicast AC method, system and device, and unicast AC method, system and device may be combined. That is, when multicast resources are insufficient, the X-RACF may request external resources from the A-RACF, and when multicast services are complete, the X-RACF returns part or all of the resources requested from the A-RACF; when unicast resources are insufficient, the A-RACF may request external resources from the X-RACF, and when unicast services are complete, the A-RACF returns part or all of the resources requested from the X-RACF. The return time and mode may be flexibly set according to requirements.

It is understandable to those skilled in the art that the foregoing X-RACF and A-RACF may also be a Transport Resource Control—Functional Entity (TRC-FE) and a Policy Decision—Functional Entity (PD-FE) in the International Telecommunication Union—Telecommunication Standardization Sector (ITU-T) standards or the corresponding functional entities in other standards.

After reading the foregoing embodiments, those skilled in the art are clearly aware that the present invention may be implemented through hardware, or through software in addition to a necessary universal hardware platform. In most circumstances, it is better to implement the present invention through software in addition to a necessary universal hardware platform. Based on such understanding, the technical solution of the invention or contributions to the prior art may be embodied by a software product. The software product is stored in a storage medium and incorporates several instructions to instruct a computer device, for example, a personal computer, a server, or a network device, to execute the method provided by each embodiment of the invention.

The foregoing embodiments are exemplary embodiments of the present invention only and are not intended to limit the present invention. Any modification, equivalent substitution or improvement without departing from the principle of the present invention should be covered in the scope of protection of the present invention.

What is claimed is:

1. A multicast Admission Control (AC) method, comprising:
presetting a multicast resource threshold for multicast services;
receiving, by a network device, a multicast request and performing multicast resource AC according to the multicast request;
sending an external resource request to a resource AC device when a sum of currently occupied multicast resources and multicast resource required in the multicast is more than the preset multicast resource threshold; and
performing a multicast operation according to an AC operation result returned by the resource AC device in response to the external resource request.

2. The method of claim 1, wherein: the method further comprises presetting a unicast resource threshold for unicast services; and
the performing AC by the resource AC device in response to the external resource request comprises: admitting the external resource request when a sum of currently occupied unicast resources and the multicast resources required in the external resource request is less than the preset unicast resource threshold.

3. The method of claim 1, further comprising:
receiving, by the network device, a multicast stop request;
stopping multicast replication according to the multicast stop request, and
releasing all or part of resources allocated by the resource AC device.

4. The method of claim 3, wherein the releasing the resources allocated by the resource AC device comprises:
releasing the resources when the network device does not require the resources; or
releasing the resources when the resource AC device detects that unicast resources are insufficient; or
releasing the resources when unicast resources required in a unicast request are insufficient after the resource AC device receives the unicast request; or
releasing the resources according to a preset resource return policy; or
releasing the resources after a preset timer expires.

5. A multicast Admission Control (AC) system, characterized by comprising a network device and a resource AC device, wherein:
the network device is configured to: preset a multicast resource threshold for multicast services; receive a multicast request, perform multicast resource AC according to the multicast request, send an external resource request to the resource AC device when a sum of currently occupied multicast resources and multicast resource required in the multicast is more than the preset multicast resource threshold, and perform a multicast operation according to an AC operation result returned by the resource AC device in response to the external resource request; and
the resource AC device is configured to receive the external resource request, perform AC according to the external resource request, and return the AC operation result to the network device.

6. The multicast AC system of claim 5, wherein the resource AC device is further configured to preset a unicast resource threshold for unicast services and admit the external resource request when a sum of currently occupied unicast resources and the multicast resources required in the external resource request is less than the preset unicast resource threshold.

7. The multicast AC system of claim 5, wherein the network device is further configured to receive a multicast stop request, stop multicast replication according to the multicast stop request, and release all or part of resources allocated by the resource AC device.

8. A unicast Admission Control (AC) method, comprising:
presetting a unicast resource threshold for unicast services;
receiving, by a resource AC device, a unicast resource request and performing unicast resource AC according to the unicast resource request;
sending an external resource request to a network device when a sum of currently occupied unicast resources and unicast resources required in the unicast request is more than the preset unicast resource threshold; and
performing a unicast operation according to an AC operation result returned by the network device in response to the external resource request.

9. The method of claim 8, wherein: the method further comprises presetting a multicast resource threshold for multicast services; and
the AC operation result returned by the network device to the external resource request is allocating external resources for the resource AC device when a sum of currently occupied multicast resources and unicast resources required in the external resource request is less than the preset multicast resource threshold.

10. The method of claim 8, wherein: the method further comprises presetting a multicast resource threshold for multicast services; and
the AC operation result returned by the network device to the external resource request is information about rejection of the external resource request when a sum of currently occupied multicast resources and unicast resources required in the external resource request is more than the preset multicast resource threshold.

11. The method of claim 8, the method further comprising process of unicast stop:
receiving, by the resource AC device, a unicast resource release request, performing AC according to the unicast resource release request, releasing resources allocated according to the unicast resource request, and releasing resources allocated by the network device.

12. The method of claim 9, the method further comprising process of unicast stop:
receiving, by the resource AC device, a unicast resource release request, performing AC according to the unicast resource release request, releasing resources allocated according to the unicast resource request, and releasing resources allocated by the network device.

13. The method of claim 11, wherein the releasing the resources allocated by the network device comprises:
releasing the resources when the network device detects that multicast resources are insufficient; or
releasing the resources when unicast resources required in a multicast request are insufficient after the network device receives the multicast request; or
releasing the resources according to a preset resource return policy; or
releasing the resources after a preset timer expires.

14. A unicast Admission Control (AC) system, characterized by comprising a resource AC device and a network device, wherein:
the resource AC device is configured to: preset a unicast resource threshold for unicast services; receive a unicast resource request, perform unicast resource AC according to the unicast resource request, send an external resource request to the network device when a sum of currently occupied unicast resources and unicast resources required in the unicast request is more than the preset unicast resource threshold, and perform a unicast operation according to an AC operation result returned by the network device in response to the external resource request;
the network device is configured to perform AC according to the external resource request, and return the AC operation result to the resource AC device.

15. The unicast AC system of claim 14, wherein the network device is further configured to preset a multicast resource threshold for multicast services; and
the AC operation result returned by the network device to the external resource request is allocating external resources for the resource AC device when a sum of currently occupied multicast resources and unicast resources required in the external resource request is less than the preset multicast resource threshold.

16. The unicast AC system of claim 14, wherein the resource AC device is further configured to receive a unicast resource release request, perform AC according to the unicast resource release request, release resources allocated according to the unicast resource request, and release resources allocated by the network device.
